(19) United States
(12) Patent Application Publication
(10) Pub. No.: US 2008/0291400 A1
(43) Pub. Date: Nov. 27, 2008

(54) PROJECTION DISPLAY DEVICE

(75) Inventor: Shinya Matsumoto, Hirakata City (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi City (JP)

(21) Appl. No.: 12/123,543

(22) Filed: May 20, 2008

(30) Foreign Application Priority Data
May 23, 2007 (JP) JP2007-136357

(51) Int. Cl. G03B 21/14

(52) U.S. Cl. 353/31

(57) ABSTRACT

A mirror unit is operable to reflect light from a lens unit for projection in such a manner that, assuming that a light guiding optical system is divided into two areas with respect to a center axis of light combined by a light combining section such as a dichroic prism, a divided area having a smaller width in a direction perpendicular to the center axis is located on the side of a projection plane as a screen. The mirror unit includes e.g. a bending mirror for bending an optical path of light through the lens unit, and a curved mirror for projecting the light reflected on the bending mirror onto the projection plane.

This application claims priority under 35 U.S.C. Section 119 of Japanese Patent Application No. 2007-136357 filed May 23, 2007, entitled “PROJECTION DISPLAY DEVICE”.

### BACKGROUND OF THE INVENTION

1. Technical Field of the Invention

The present invention relates to a projection display device for projecting an image on an imager onto a projection plane, and more particularly to a projection display device for enlarging and projecting light modulated by an imager in an oblique direction.

2. Disclosure of Related Art

A conventional projection display device (hereinafter, called as a “projector”) is configured in such a manner that light from an optical engine is projected onto a screen via a projection lens. There is proposed a method for reflecting light from a projection lens by an aspherical mirror, as a method for increasing a projection angle of light (hereinafter, called as “projection light”) to be projected from a projector onto a screen. In use of the method, as shown in FIGS. 9A and 9B, since projection light is incident onto a screen in an oblique direction, there is less likelihood that the projection light may be blocked by an obstacle or a like object. Also, the above method is advantageous in suppressing an increase in size and cost of the projector, because projection light with a wide angle can be secured with use of a relatively small aspherical mirror.

In the projector of the above type, as the throw distance (H0) shown in FIGS. 9A and 9B is reduced, there is less likelihood that projection light may be blocked by an obstacle or a like object, thereby suppressing generation of a shadow in a projected image.

For instance, in the usage pattern of FIG. 9A, as the throw distance (H0) is reduced, there is less likelihood that projection light may be blocked by a presenter standing near the screen, thereby suppressing generation of a shadow in a projected image. Similarly, in the usage pattern of FIG. 9B, as the throw distance (H0) is reduced, there is less likelihood that projection light may be blocked by a person seated around a desk where the projector is installed, or an object on the desk. Accordingly, in the projector of the above type, a smaller throw distance (H0) is advantageous in enhancing the operability and the utility value of the projector.

### SUMMARY OF THE INVENTION

It is a primary object of the present invention to provide a projection display device that enables to advantageously suppress an increase in the distance i.e. the throw distance (H0) from an exit position of projection light to a projection plane as a screen.

A projection display device according to a first aspect of the invention comprises: a light source; a plurality of imagers individually arranged on an identical plane in correspondence to light of a wavelength band to be modulated; a light guiding optical system for guiding the light of the wavelength bands to be outputted from the light source to the corresponding imagers, respectively; a light combining section for combining the light of the wavelength bands modulated by the imagers to guide the combined light in a direction parallel to the plane; a lens unit for allowing incidence of the light combined by the light combining section; and a mirror unit for projecting the light from the light combining section through the lens unit onto a projection plane. The mirror unit is operable to reflect the light from the lens unit for projection onto the projection plane in such a manner the projection plane is perpendicular to the plane, and, assuming that the light guiding optical system is divided into two areas with respect to a center axis of the light combined by the light combining section, a divided area having a smaller width in a direction perpendicular to the center axis is located on the side of the projection plane.

In the above arrangement, since the light reflecting direction is defined by the mirror unit, the distance i.e. the throw distance (H0) between the exit position of projection light and the projection plane is reduced. The feature will be described in detail in the following description of the embodiments.

Preferably, the mirror unit may include a bending mirror for bending an optical path of the light from the light combining section through the lens unit, and a curved mirror for projecting the light reflected on the bending mirror onto the projection plane. The bending mirror may not necessarily be provided independently of the lens unit, but may be integrally mounted on a lens holder or a like member for holding the lens unit. Further alternatively, the curved mirror may include e.g. an aspherical mirror or a free curved mirror.

In the first aspect, the imagers may be operable to modulate light of the wavelength bands corresponding to red, green, and blue. The arrangement, however, does not exclude an imager for modulating light of a wavelength band other than the above. For instance, an imager for modulating light of a wavelength band corresponding to yellow may be additionally arranged on a plane other than the aforementioned plane.

In the case where the three imagers are arranged on the identical plane, as described above, the light guiding optical system may be operable to separate the light to be outputted from the light source into the light of the wavelength bands to guide the light of the wavelength bands to the corresponding imagers, respectively. In this arrangement, the light guiding optical system may be configured in such a manner that an optical path, among optical paths of the light of the wavelength bands after light separation, at a position optically farthest from the light source, is closer to the projection plane. As will be described in the following, the above arrangement enables to further reduce the distance i.e. the throw distance (H0) between the exit position of projection light and the projection plane.

Generally, in the case where light from a light source is gradually converged by a lens group to guide the converged light to an imager, the sectional area of the light is reduced, as the light is optically farther from the light source. In the above condition, the size of an optical component is reduced, as the optical component is located optically farther from the light source. Accordingly, the width of an optical path is reduced, as the optical path is optically farther from the light source. Thus, as described above, making the optical path at the position optically farthest from the light source, among the optical paths of the light of the wavelength bands after light separation, closer to the projection plane enables to suppress an increase of the width of the optical path of the light guiding optical system, located on the side of the projection plane. Consequently, the distance i.e. the throw distance (H0) between the exit position of projection light and the projection plane can be reduced.

A projection display device according to a second aspect of the invention comprises: a light source; reflective imagers arranged on an identical plane in correspondence to light of three wavelength bands different from each other; a light separating section for separating the light to be outputted from the light source into the light of a first wavelength band, the light of a second wavelength band, and the light of a third wavelength band, and guiding the light of the first wavelength band, the light of the second wavelength band, and the light of the third wavelength band in a direction parallel to the plane, respectively; a first light guiding optical system for guiding the light of the first wavelength band and the light of the second wavelength band, separated by the light separating section, to the corresponding ones of the imagers, respectively, and combining the light of the first wavelength band and the light of the second wavelength band modulated by the imagers to guide the combined light in a direction parallel to the plane; a second light guiding optical system for guiding the light of the third wavelength band, separated by the light separating section, to the corresponding one of the imagers, and combining the light of the third wavelength band modulated by the imager, and the light generated by combining the light of the first wavelength band and the light of the second wavelength band by the first light guiding optical system to guide the combined light in a direction parallel to the plane; a lens unit for allowing incidence of the light combined by the second light guiding optical system; and a mirror unit for projecting the light through the lens unit onto a projection plane. The mirror unit is operable to reflect the light from the lens unit for projection onto the projection plane in such a manner that the projection plane is perpendicular to the plane, and, assuming that an optical system constituted of the first light guiding optical system and the second light guiding optical system is divided into two areas with respect to a center axis of the light combined by the second light guiding optical system, a divided area having a smaller width in a direction perpendicular to the center axis is located on the side of the projection plane.

In the above arrangement, similarly to the arrangement of the first aspect, since the light reflecting direction is adjusted by the mirror unit, the distance i.e. the throw distance (H0) between the exit position of projection light and the projection plane is reduced. An arrangement example of the second aspect will be described in detail referring to FIGS. 6 through 8.

### BRIEF DESCRIPTION OF THE DRAWINGS

These and other objects, and novel features of the present invention will become more apparent upon reading the following detailed description along with the accompanying drawings.

FIG. 1 is a diagram showing an arrangement of a projector, as an optical system, in accordance with a first embodiment of the invention.

FIG. 2 is a diagram showing an arrangement example of the projector in the first embodiment.

FIG. 3 is a diagram showing another arrangement example of the projector in the first embodiment.

FIG. 4 is a diagram showing yet another arrangement example of the projector in the first embodiment.

FIGS. 5A and 5B are diagrams showing usage patterns of the projector in the first embodiment.

FIG. 6 is a diagram showing an arrangement example of a projector in accordance with a second embodiment of the invention.

FIG. 7 is a diagram showing another arrangement example of the projector in the second embodiment.

FIG. 8 is a diagram showing yet another arrangement example of the projector in the second embodiment.

FIGS. 9A and 9B are diagrams showing arrangement examples in the case where a wide angle is secured by an aspherical mirror.

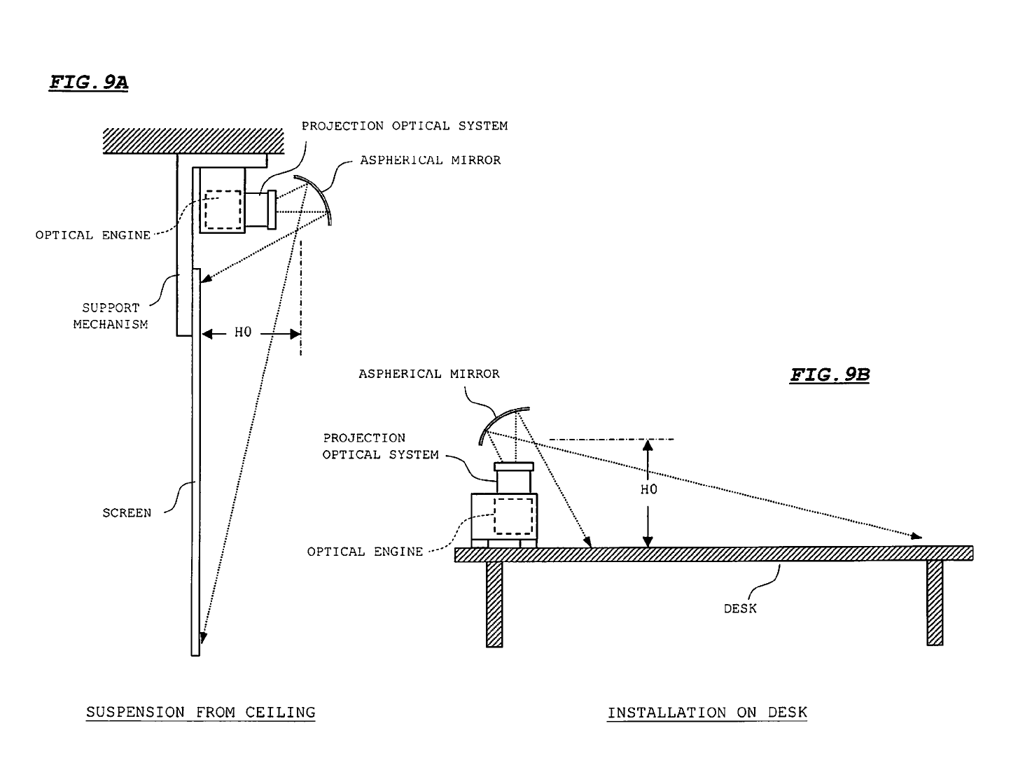

The drawings are provided mainly for describing the present invention, and do not limit the scope of the present invention.

### DESCRIPTION OF PREFERRED EMBODIMENT

### First Embodiment

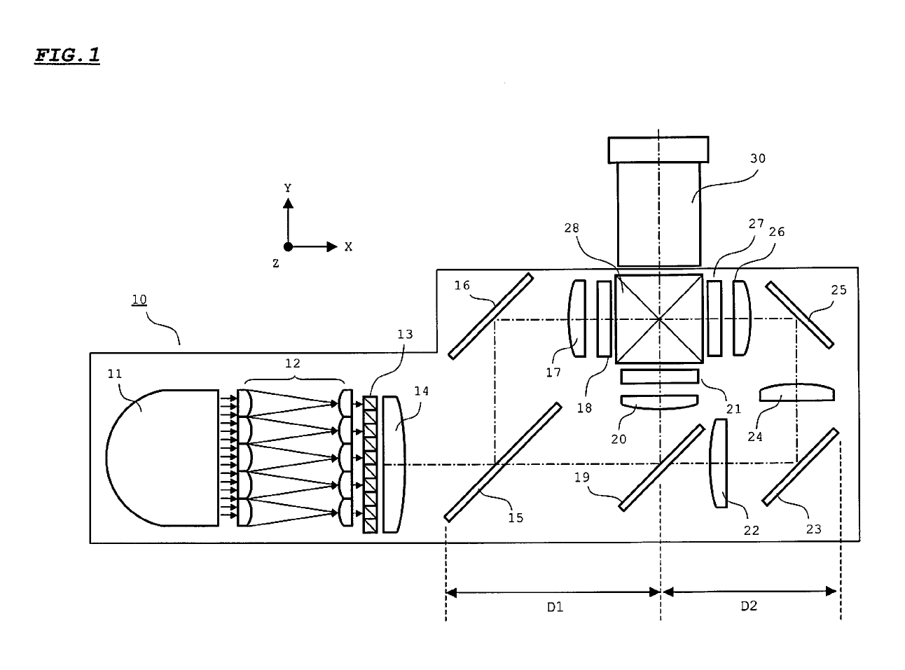

FIG. 1 shows an arrangement of a projector in accordance with the first embodiment of the invention. The first embodiment is an application of the invention, and is directed to a projector using a transmissive liquid crystal panel as an imager. The embodiment corresponds to the inventions defined in claims 1 through 4.

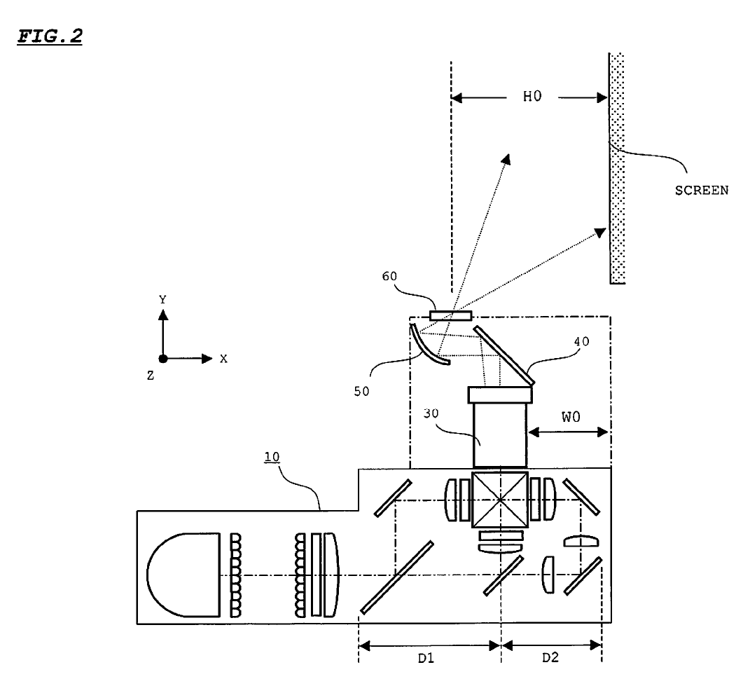

Referring to FIG. 1, the reference numeral 10 indicates an optical engine, and the reference numeral 30 indicates a projection lens as a lens unit. The optical engine 10 includes a light source 11, and an optical system from a fly-eye integrator 12 to a dichroic prism 28. The projector further includes a bending mirror 40 and an aspherical mirror 50 as a mirror unit, other than the above constituent elements. The constituent elements will be described later referring to FIG. 2.

The light source 11 has a lamp and a reflector, and is adapted to output substantially parallel light to the fly-eye integrator 12. The fly-eye integrator 12 includes a first integrator and a second integrator having fly-eye lenses, and imparts a lens function to the light to be incident from the light source 11 in such a manner that the light amount distribution of light to be incident onto liquid crystal panels 18, 21, and 27 is substantially made uniform. Specifically, light transmitted through the fly-eye lenses is allowed to be incident onto the liquid crystal panels 18, 21, and 27 with an aspect ratio (in this embodiment, the aspect ratio is 16:9) of the liquid crystal panels 18, 21, and 27.

A PBS (polarized beam splitter) array 13 is formed by arranging a plurality of PBSs and half-wavelength plates in an array pattern, and is adapted to align polarization directions of light incident from the fly-eye integrator 12 in an identical direction. A condenser lens 14 imparts a condensing function to the light incident from the PBS array 13.

A dichroicmirror 15, for instance, reflects solely light (hereinafter, called as “R light”) of a wavelength band corresponding to red, and transmits light (hereinafter, called as “B light”) of a wavelength band corresponding to blue, and light (hereinafter, called as “G light”) of a wavelength band corresponding to green, among the light incident from the condenser lens 14. A mirror 16 reflects the R light reflected on the dichroic mirror 15 for incidence onto a condenser lens 17.

The condenser lens 17 imparts a lens function to the R light in such a manner that the R light is incident onto the liquid crystal panel 18 as substantially parallel light. The liquid crystal panel 18 is driven in accordance with a video signal for red color, and modulates the R light depending on a driving condition of the liquid crystal panel 18. The R light transmitted through the condenser lens 17 is incident onto the liquid crystal panel 18 via an incident-side polarizer (not shown).

A dichroic mirror 19, for instance, reflects solely the G light among the B light and the G light transmitted through the dichroic mirror 15. A condenser lens 20 imparts a lens function to the G light in such a manner that the G light is incident onto the liquid crystal panel 18 as substantially parallel light. The liquid crystal panel 21 is driven in accordance with a video signal for green color, and modulates the G light depending on a driving condition of the liquid crystal panel 21. The G light transmitted through the condenser lens 20 is incident onto the liquid crystal panel 21 via an incident-side polarizer (not shown).

Relay lenses 22 and 24 impart a lens function to the B light in such a manner that the incident condition of the B light with respect to the liquid crystal panel 27 is substantially equal to the incident conditions of the R light and the G light with respect to the liquid crystal panels 17 and 20. Mirrors 23 and 25 are operable to change the optical path of the B light in such a manner that the B light transmitted through the dichroic mirror 19 is guided to the liquid crystal panel 27.

A condenser lens 26 imparts a lens function to the B light in such a manner that the B light is incident onto the liquid crystal panel 27 as substantially parallel light. The liquid crystal panel 27 is driven in accordance with a video signal for blue color, and modulates the B light depending on a driving condition of the liquid crystal panel 27. The B light transmitted through the condenser lens 26 is incident onto the liquid crystal panel 27 via an incident-side polarizer (not shown).

The dichroic prism 28 combines the R light, the G light, and the B light that have been modulated by the liquid crystal panels 18, 21, and 27, and transmitted through a corresponding output-side polarizer (not shown) for incidence onto the projection lens 30.

The projection lens 30 includes a lens group for focusing projection light to form a projected image on a projection plane as a screen, and an actuator for controlling a zoom condition and a focus condition of the projected image by displacing a part of the lens group in an optical axis direction.

Among the optical systems shown in FIG. 1, an optical system (hereinafter, called as “R light guiding optical system”) constituted of the dichroic mirror 15, the mirror 16, and the condense lens 17 corresponds to a first light guiding section defined in claim 4; an optical system (hereinafter, called as “G light guiding optical system”) constituted of the dichroic mirror 19 and the condense lens 20 corresponds to a second light guiding section defined in claim 4; and an optical system (hereinafter, called as “B light guiding optical system”) constituted of the dichroic mirror 19, the relay lenses 22 and 24, the mirrors 23 and 25, and the condense lens 26 corresponds to a third light guiding section defined in claim 4.

In the arrangement example shown in FIG. 1, light from the light source 11 is converged by the condenser lens 14. Accordingly, a sectional area of the light transmitted through the condenser lens 14 is gradually reduced, as the light is directed toward the liquid crystal panels 18, 21, and 27. Thus, the size of the optical component constituting the optical system is reduced, as the optical component is optically located farther from the light source 11. For instance, the size of the mirror 23, 25 is considerably small, as compared with the size of the dichroic mirror 15 disposed immediately behind the condenser lens 14.

Accordingly, as compared with the width of the optical path of the R light guiding optical system and the width of the optical path of the G light guiding optical system, in other words, the width of the optical component arranged in a position perpendicular to the optical axis, the width of the optical path of the B light guiding optical system is reduced. Under the above condition, in the case where the entirety of the optical systems is divided into two areas with respect to a center axis of light combined by the dichroic prism 28, the width D2 is smaller than the width D1 in a direction perpendicular to the center axis. Accordingly, as shown in FIG. 2, the distance i.e. the throw distance (H0) between the exit position of projection light and the projection plane can be reduced by arranging the B light guiding optical system on the side of the screen.

FIG. 2 is a diagram showing an arrangement, wherein the bending mirror 40 and the aspherical mirror 50 are provided, in addition to the arrangement shown in FIG. 1. The bending mirror 40 reflects the light from the projection lens 30 in a direction toward the aspherical mirror 50. The aspherical mirror 50 increases the angle of projection light incident from the bending mirror 40 for projection onto the projection plane as the screen. Alternatively, the aspherical mirror 50 may be shaped into a free curved mirror. A projection window 60 is constituted of a light-transmissive plate member, and is arranged at a position, where the projection light is allowed to pass, of a casing in which the projection lens 30, the bending mirror 40, and the aspherical mirror 50 are housed. The projection window 60 is provided as an anti-dust measure or the like to protect the aspherical mirror 50 from dust or prevent intrusion of dusts.

After the optical path of the light from the projection lens 30 i.e. combined light generated by combining the modulated R light, G light, and B light is bent by the bending mirror 40, the combined light is enlarged and projected onto the projection plane as the screen by the aspherical mirror 50.

In the arrangement example of FIG. 2, the light from the projection lens 30 is bent for projection in such a manner that the B light guiding optical system is located on the side of the screen. This arrangement enables to reduce the distance (WO) in FIG. 2, whereby an increase of the distance (H0) from the exit position of projection light to the projection plane as the screen is suppressed. Thus, there is less likelihood that projection light may be blocked by an obstacle or a like object, thereby enabling to enhance the operability and the utility value of the projector.

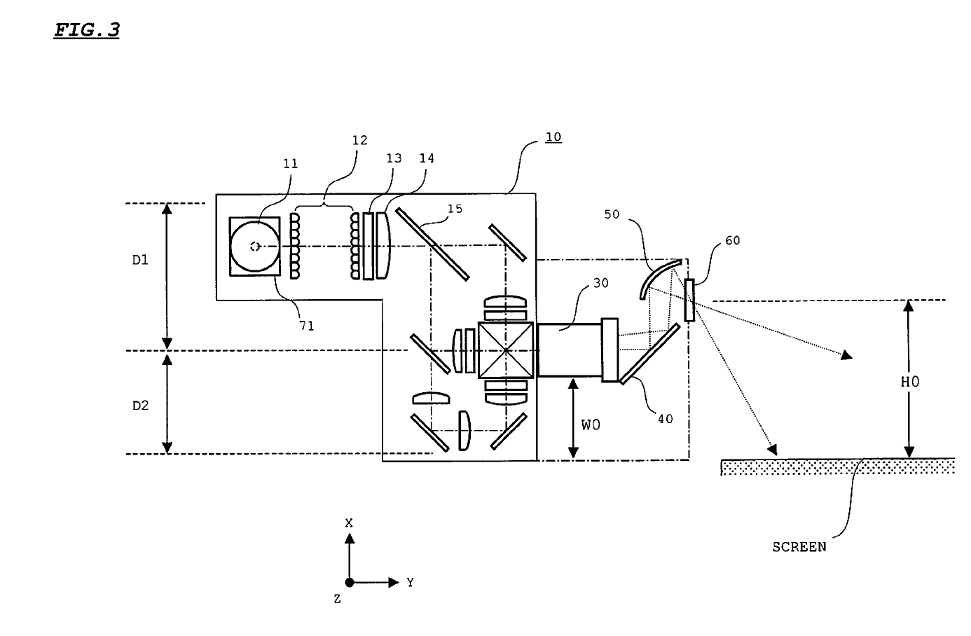

In the arrangement example shown in FIG. 2, the light from the light source 11 is allowed to be incident onto the dichroic mirror 15 in X axis direction. Alternatively, for instance, as shown in FIG. 3, light from a light source 11 may be allowed to be incident onto a dichroic mirror 15 in Y axis direction.

In the arrangement example shown in FIG. 3, the light source 11 is arranged at such a position as to output the light in Z axis direction. The light from the light source 11 is reflected in Y axis direction by a mirror 71. Thereafter, the reflected light is incident onto the dichroic mirror 15 via a fly-eye integrator 12, a PBS array 13, and a condenser lens 14. In the arrangement example shown in FIG. 3, the dichroic mirror 15 is operable to transmit R light, and reflect B light and G light. The optical path of constituent elements posterior to the dichroic mirror 15 is substantially the same as the corresponding optical path shown in FIG. 1.

In the arrangement example shown in FIG. 3, similarly to the arrangement shown in FIG. 1, the width D2 is smaller than the width D1. Accordingly, as shown in FIG. 3, reflecting the light from a projection lens 30 for projection in such a manner that the B light guiding optical system is located on the side of the screen enables to reduce the distance (W0) in FIG. 3. Thereby, an increase of the distance (H0) from the exit position of the projection light to the projection plane as the screen can be suppressed.

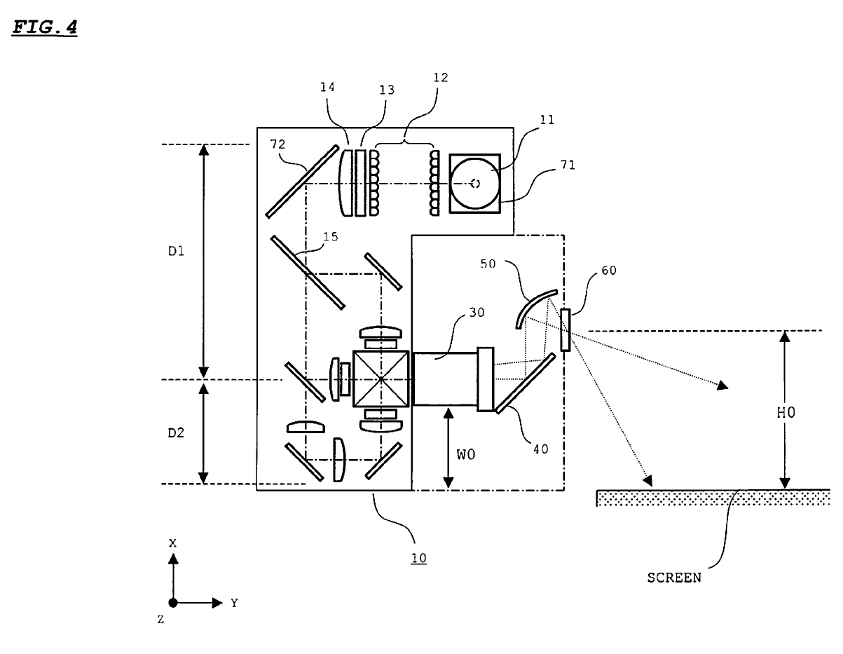

Alternatively, as shown in FIG. 4, an optical system may be configured in such a manner that an optical path of constituent elements corresponding to the constituent elements from the light source 11 to the condenser lens 14 in the arrangement example shown in FIG. 3 is bent in Y axis direction. In the modification, a light source 11 is arranged at such a position as to output light in Z axis direction. The light from the light source 11 is reflected on a mirror 71 in Y axis direction. Thereafter, the light is reflected on a mirror 72 via a fly-eye integrator 12, a PBS array 13, and a condenser lens 14 for incidence onto a dichroic mirror 15. The optical path of constituent elements posterior to the dichroic mirror 15 is substantially the same as the corresponding optical path shown in FIG. 1.

In the arrangement example shown in FIG. 4, the optical path of constituent elements from the light source 11 to the condenser lens 14 is bent in Y axis direction. Accordingly, as compared with the arrangement example shown in FIG. 2, the arrangement example shown in FIG. 4 is advantageous in miniaturizing the projector. Also, as compared with the arrangement example shown in FIG. 3, the arrangement example shown in FIG. 4 is advantageous in miniaturizing the projector, because a protruded portion corresponding to the constituent elements from the light source 11 to the condenser lens 14 is located above the projection lens 30.

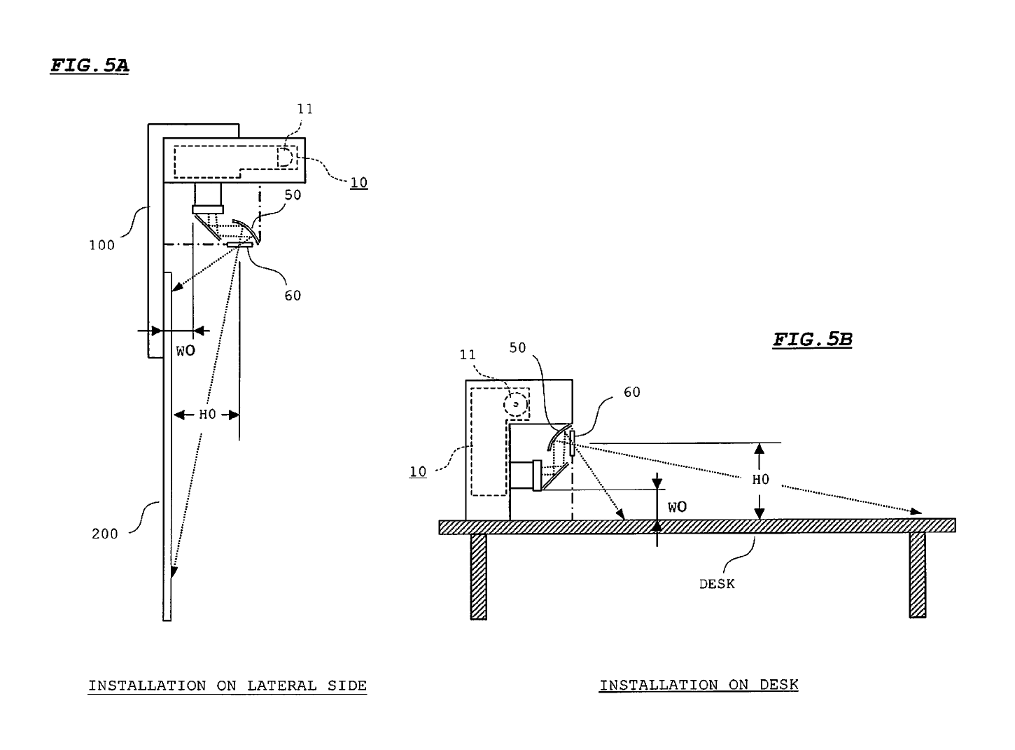

FIGS. 5A and 5B are diagrams showing usage patterns of the projector in the first embodiment. FIG. 5A shows a usage pattern corresponding to a condition that the projector as the arrangement example shown in FIG. 2 is arranged on a lateral side of the screen in use. FIG. 5B shows a usage pattern corresponding to a condition that the projector as the arrangement example shown in FIG. 4 is installed on a desk in use. In the usage pattern shown in FIG. 5A, the projector and a screen 200 are integrally mounted via a support mechanism 100.

In any of the usage patterns, since an increase of the distance (W0) can be suppressed as described above, an increase of the distance (H0) from the exit position of projection light to the projection plane as the screen can be suppressed.

As described above, in the first embodiment, an increase of the distance (H0) from the exit position of projection light to the projection plane as the screen can be suppressed. This enables to reduce likelihood that projection light may be blocked by an obstacle or a like object, thereby enabling to enhance the operability and the utility value of the projector.

### Second Embodiment

In the first embodiment, a transmissive liquid crystal panel is used as an imager. The present invention may be applied to a so-called LCOS (Liquid Crystal on Silicon) projector, wherein a reflective liquid crystal panel is used as an imager.

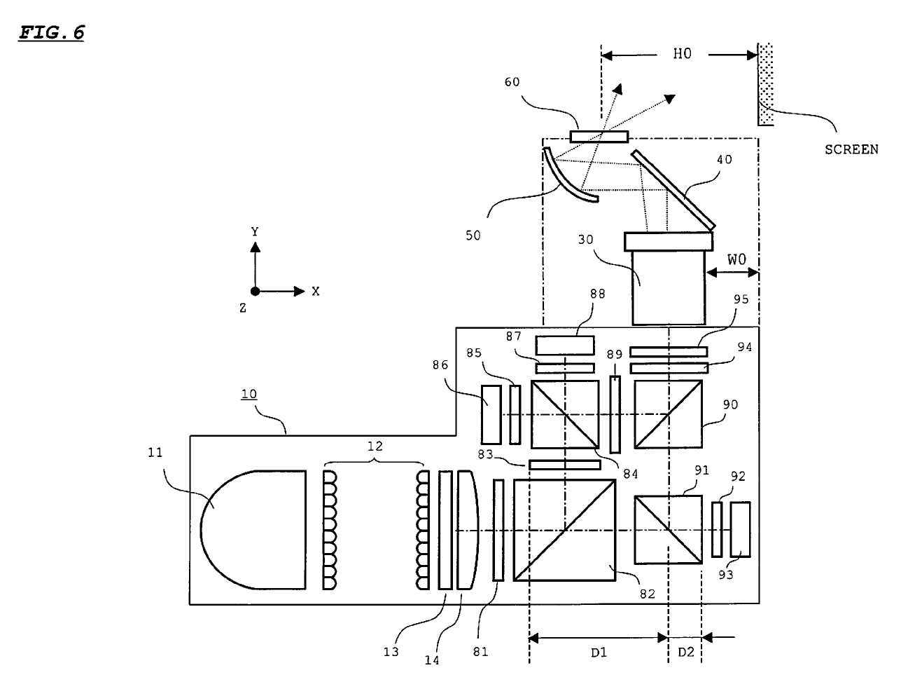

FIG. 6 shows an arrangement example, in which a reflective liquid crystal panel is used. The arrangement example corresponds to the inventions defined in claims 1, 2, 5, and 6. An arrangement from a light source 11 to a condenser lens 14 in the second embodiment is substantially the same as the corresponding arrangement in the first embodiment.

Light transmitted through the condenser lens 14 is S-polarized light with respect to a polarization plane of a polarized beam splitter (PBS) 82. Among the S-polarized light, G light is converted into P-polarized light by a half wavelength plate 81 having wavelength selectivity. Accordingly, the G light is transmitted through the PBS 82, and B light and R light are reflected on the PBS 82.

Among the B light and the R light reflected on the PBS 82, the R light is converted into P-polarized light by a half wavelength plate 83 having wavelength selectivity. Accordingly, among the B light and the R light, the B light is reflected on a PBS 84, and the R light is transmitted through the PBS 84.

The B light reflected on the PBS 84 is converted into circularly-polarized light by a quarter wavelength plate 85 for incidence onto a reflective liquid crystal panel 86. In the second embodiment, by causing the B light to reciprocate with respect to a liquid crystal panel 86, the turning direction of the circularly-polarized light is inverted merely at a pixel position in an on-state, for example. Accordingly, when the B light is transmitted through the quarter wavelength plate 85 again, the B light is P-polarized light with respect to the PBS 84 at a pixel position in an on-state, and S-polarized light with respect to the PBS 84 at a pixel position in an off-state. As a result of the operation, merely the B light as P-polarized light at the pixel position in an on-state is transmitted through the PBS 84, and incident onto a PBS 90 via a half wavelength plate 89.

Similarly, by causing the R light transmitted through the PBS 84 via the half wavelength plate 83 to reciprocate between a quarter wavelength plate 87 and a reflective liquid crystal panel 88, merely a light component of the R light at a pixel position in an on-state is reflected on the PBS 84, and guided to a projection lens 30. The R light is converted into P-polarized light by a half wavelength plate 89 having wavelength selectivity for incidence onto the PBS 90.

As described above, both of the B light and the R light modulated by the liquid crystal panels 86 and 88 are incident onto the PBS 90 in an identical polarization direction i.e. a polarization direction of P-polarized light with respect to the PBS 84. In the second embodiment, since the PBS 90 is configured in such a manner that the B light and the R light are incident as S-polarized light, both of the B light and the R light are reflected on the PBS 90.

By causing the G light transmitted through the PBS 82 to transmit through a PBS 91, and then reciprocate between a quarter wavelength plate 92 and a reflective liquid crystal panel 93, merely a light component of the G light at a pixel position in an on-state is reflected on the PBS 91 for incidence onto the PBS 90. Since the G light is incident onto the PBS 90 as P-polarized light, the G light is transmitted through the PBS 90.

As described above, the B light, the R light, and the G light modulated by the liquid crystal panels 86, 88, and 93 are combined while transmitted through the PBS 90. Then, after the polarization direction of the combined light is rotated by 90 degrees by a half wavelength plate 94, the combined light is incident onto the projection lens 30 via a polarizer 95.

In the arrangement example shown in FIG. 6, the half wavelength plate 81 and the PBS 82 correspond to a light separating section defined in claim 5. The half wavelength plate 83 and the PBS 84 correspond to a first light guiding optical system defined in claim 5. The half wavelength plate 89, the PBS 90, and the PBS 91 correspond to a second light guiding optical system defined in claim 5.

In the arrangement example shown in FIG. 6, the PBS 91 is arranged on the center axis of light combined by the PBS 90. Accordingly, if the light guiding optical systems are divided into two areas with respect to the center axis, the width D1 is smaller than the width D2 in a direction substantially perpendicular to the center axis. Accordingly, as shown in FIG. 6, arranging the divided area corresponding to the width D2 on the side of the screen enables to reduce the distance i.e. the throw distance (H0) between the exit position of projection light and the projection plane.

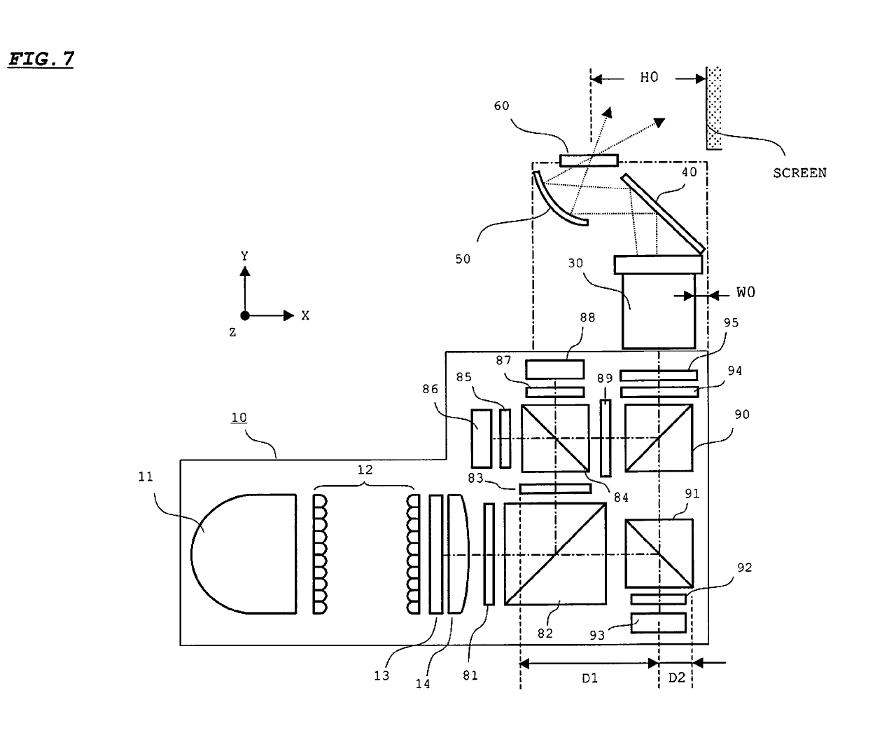

In the arrangement example shown in FIG. 6, the quarter wavelength plate 92 and the liquid crystal panel 93 are aligned in X axis direction with respect to the PBS 91. Alternatively, as shown in FIG. 7, the quarter wavelength plate 92 and the liquid crystal panel 93 may be arranged in Y axis direction orthogonal to X axis with respect to the PBS 91. In the modification, the PBS 91 is operable to reflect G light transmitted through the PBS 82. The modification enables to further reduce the distance (W0), as compared with the arrangement example shown in FIG. 6, which is further advantageous in suppressing an increase of the throw distance (H0).

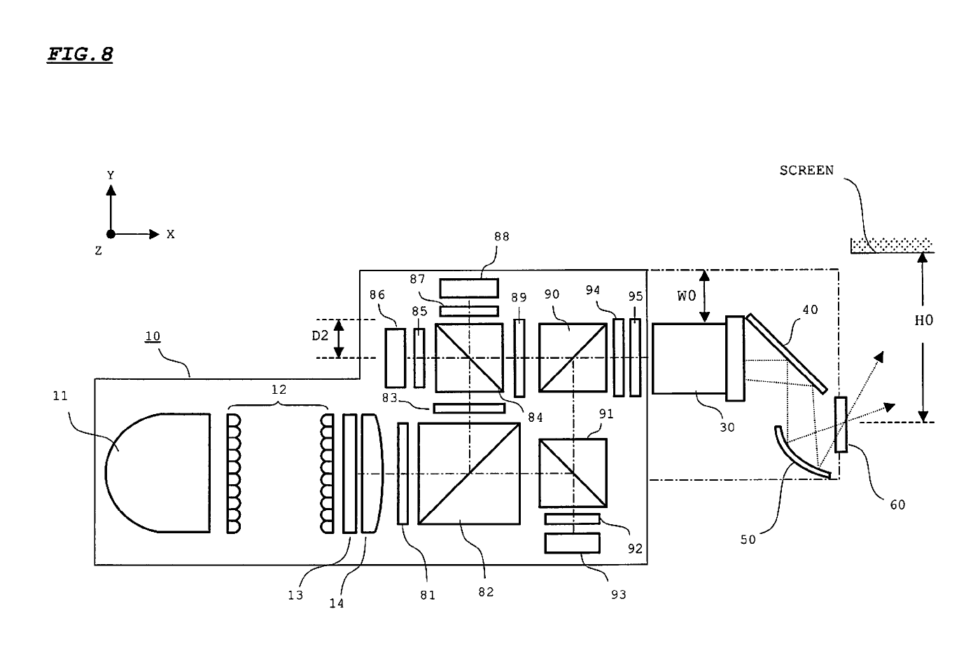

In the arrangement examples shown in FIGS. 6 and 7, the optical system is configured in such a manner that the optical axis of the projection lens 30 is aligned in Y axis direction. Alternatively, as shown in FIG. 8, the optical system may be configured in such a manner that the optical axis of the projection lens 30 is aligned in X axis direction. In the modification, the PBS 90 is operable to transmit R light and B light to be incident from the half wavelength plate 89, and reflect G light to be incident from the PBS 91.

The embodiments of the invention have the arrangements as described above. The invention, however, is not limited to the foregoing embodiments. The embodiments of the invention may be modified in various ways other than the above.

For instance, in the foregoing embodiments, B light, G light, and R light are modulated by liquid crystal panels, and the modulated B light, G light, and R light are combined by a dichroic prism or a PBS. Alternatively, light of a wavelength band other than the wavelength bands of the B light, the G light, and the R light, e.g. light of a wavelength band corresponding to yellow, may be modulated by a corresponding liquid crystal panel. Then, the modulated light may be combined with the B light, G light, and R light for incidence onto the projection lens 30.

In the arrangement example shown in FIG. 1, the liquid crystal panel for B light is arranged at a position closest to the projection plane as the screen, and the liquid crystal panel for R light is arranged at a position farthest from the projection plane as the screen. Alternatively, in the case where color purity of B light is increased, the liquid crystal panels may be arranged in the order of liquid crystal panels for R light, G light, and B light at a position closer to the projection plane as the screen. Further alternatively, the liquid crystal panel for R light, or the liquid crystal panel for B light may be arranged at a position of the liquid crystal panel for G light in the arrangement example shown in FIG. 1.

In the case where a reflective liquid crystal panel is used, various arrangements other than the arrangement examples shown in FIGS. 6 through 8 may be applied. For instance, in the arrangement examples shown in FIGS. 6 through 8, B light, G light, and R light are separated and combined by combining PBSs and half wavelength plates having wavelength selectivity. Alternatively, as recited in Japanese Unexamined Patent Publication No. 2000-284228, B light, G light, and R light may be separated and combined by using a dichroic mirror and a dichroic prism.

In the foregoing embodiments, the projection lens 30 and the bending mirror 40 are provided independently of each other. Alternatively, the projection lens 30 and the bending mirror 40 may be integrated into one unit. For instance, a bending mirror 40 may be arranged in a lens holder for housing a lens group i.e. a projection lens 30 at such a position that light transmitted through the lens group is reflected on the bending mirror 40 in a direction orthogonal to the optical axis of the lens group. In the modification, the lens holder is formed with a cutaway serving as an optical path at a position where the light reflected on the bending mirror 40 is allowed to pass.

In the foregoing embodiments, a lamp is used as a light source. Alternatively, there may be used a light source for emitting light of wavelength bands, e.g. a LED (Light Emitting Diode), or a LD (Laser Diode).

Also, the present invention may be applied to a DLP (Digital Light Processing) projector.

The embodiments of the present invention may be changed or modified in various ways, according to needs, as far as such changes and modifications do not depart from the scope of the present invention hereinafter defined.

What is claimed is:

1. A projection display device, comprising:
a light source;
a plurality of imagers individually arranged on an identical plane in correspondence to light of a wavelength band to be modulated;
a light guiding optical system for guiding the light of the wavelength bands to be outputted from the light source to the corresponding imagers, respectively;
a light combining section for combining the light of the wavelength bands modulated by the imagers to guide the combined light in a direction parallel to the plane;
a lens unit for allowing incidence of the light combined by the light combining section; and
a mirror unit for projecting the light from the light combining section through the lens unit onto a projection plane, wherein
the mirror unit is operable to reflect the light from the lens unit for projection onto the projection plane in such a manner the projection plane is perpendicular to the plane, and, assuming that the light guiding optical system is divided into two areas with respect to a center axis of the light combined by the light combining section, a divided area having a smaller width in a direction perpendicular to the center axis is located on the side of the projection plane.

2. The projection display device according to claim 1, wherein
the mirror unit includes a bending mirror for bending an optical path of the light from the light combining section through the lens unit, and a curved mirror for projecting the light reflected on the bending mirror onto the projection plane.

3. The projection display device according to claim 1, wherein
the imagers are light transmissive and individually arranged in correspondence to the light of three wavelength bands different from each other, and
the light guiding optical system is operable to separate the light to be outputted from the light source into the light of the three wavelength bands to guide the light of the three wavelength bands to the corresponding imagers, respectively, and is configured in such a manner that an optical path, among optical paths of the light of the three wavelength bands, at a position optically farthest from the light source, is closer to the projection plane.

4. The projection display device according to claim 3, wherein
the three imagers are arranged in a first direction perpendicular to the center axis, a second direction parallel to the center axis, and a third direction opposite to the first direction, respectively, while surrounding the light combining section,
the light guiding optical system is operable to allow incidence of the light of the three wavelength bands onto the imagers in the first direction, the second direction, and the third direction, respectively,
the light guiding optical system includes:
a first light guiding section for separating the light of a first wavelength band from the light to be outputted from the light source at first to guide the light of the first wavelength band to the corresponding one of the imagers in the first direction; and
a second light guiding section and a third light guiding section for separating the light of a second wavelength band and the light of a third wavelength band from the light to be outputted from the light source, after separation of the light of the first wavelength band by the first light guiding section, to guide the light of the second wavelength band and the light of the third wavelength band to the corresponding ones of the imagers in the second direction and the third direction, respectively, and
the third light guiding section is arranged closer to the projection plane than the first light guiding section and the second light guiding section.

5. A projection display device, comprising:
a light source;
reflective imagers arranged on an identical plane in correspondence to light of three wavelength bands different from each other;
a light separating section for separating the light to be outputted from the light source into the light of a first wavelength band, the light of a second wavelength band, and the light of a third wavelength band, and guiding the light of the first wavelength band, the light of the second wavelength band, and the light of the third wavelength band in a direction parallel to the plane, respectively;
a first light guiding optical system for guiding the light of the first wavelength band and the light of the second wavelength band, separated by the light separating section, to the corresponding ones of the imagers, respectively, and combining the light of the first wavelength band and the light of the second wavelength band modulated by the imagers to guide the combined light in a direction parallel to the plane;
a second light guiding optical system for guiding the light of the third wavelength band, separated by the light separating section, to the corresponding one of the imagers, and combining the light of the third wavelength band modulated by the imager, and the light generated by combining the light of the first wavelength band and the light of the second wavelength band by the first light guiding optical system to guide the combined light in a direction parallel to the plane;
a lens unit for allowing incidence of the light combined by the second light guiding optical system; and
a mirror unit for projecting the light through the lens unit onto a projection plane, wherein
the mirror unit is operable to reflect the light from the lens unit for projection onto the projection plane in such a manner that the projection plane is perpendicular to the plane, and, assuming that an optical system constituted of the first light guiding optical system and the second light guiding optical system is divided into two areas with respect to a center axis of the light combined by the second light guiding optical system, a divided area having a smaller width in a direction perpendicular to the center axis is located on the side of the projection plane.

6. The projection display device according to claim 5, wherein
the mirror unit includes a bending mirror for bending an optical path of the light through the lens unit, and a curved mirror for projecting the light reflected on the bending mirror onto the projection plane.
